(19) United States
(12) Patent Application Publication
(10) Pub. No.: US 2007/0006854 A1
(43) Pub. Date: Jan. 11, 2007

(54) Fuel vaporizer

(76) Inventor: Ron Price, (US)

Correspondence Address: MICHAEL RIES, 1747A VERMONT DRIVE, ELK GROVE, IL, 60007, US

(21) Appl. No.: 11/127,323

(22) Filed: Jul. 6, 2005

(51) Int. Cl. F02M 31/18

(52) U.S. Cl. 123/555

(57) ABSTRACT

The present invention is a fuel vaporizer that will greatly increase power and economy in fuel powered engines while producing far less pollution. The present invention has a fuel chamber, air inlet and heating element that aerate fuel while vibrating and heating the fuel from a liquid to a more combustible gaseous vapor.

### TECHNICAL FIELD & BACKGROUND

The present invention generally relates to the field of fuel vaporizers. More specifically, the present invention relates to a fuel vaporizer that will greatly increase power and economy in fuel powered engines while producing far less pollution.

There is a need for conserving gas while increasing power and creating less pollution. The present invention has a fuel chamber, air inlet and heating element that aerate fuel while vibrating and heating the fuel from a liquid to a more combustible gaseous vapor. Other designs use many moving parts that can breakdown also heat is used but they do not use air or vibration to complete the vaporization process. Other attempts at vaporization make the mistake of saying that vapors are dry this in not correct for they are damp. Before the computer age another attempt at vaporization was a float. The present invention includes heat, air, and vibration along with usable at any angle compared to another design that attempts vaporization with heat only and a fuel level that would fail at extreme angles.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a side view with an inner core sectioned of a fuel vaporizer in accordance with one embodiment of the present invention; and

FIG. 2 is a side view of a fuel vaporizer in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation. The phrase in one embodiment is used repeatedly. The phrase generally does not refer to the same embodiment, however, it may. The terms comprising, having and including are synonymous, unless the context dictates otherwise.

A fuel vaporizer has a fuel chamber or inner core, an air intake, and a heating element that aerates fuel while vibrating and heating it from a liquid to a more combustible gaseous vapor. The more combustible-gaseous vapor conserves gas while creating a higher power and produces far less pollution all from the vaporization process. The intake manifold houses the inner core. Fuel or gas is introduced into the system's inner core by computerized means to control the proper amount to be vaporized. The heating element in conjunction with the vibrator produces a shaker effect to promote the vaporization process. The spring mounts keep the inner core suspended to keep the vibrating consistent. An air inlet valve, also computerized, brings air into the inner core to further the vaporization before it enters the manifold by computerized outlet valves or fuel pressure valves. There are multiple computerized pressure valves that regulate the release of excess vapors within the intake manifold which are re-circulated back into the fuel supply. The vapors from the inner core are computably introduced to the engine from within the intake manifold.

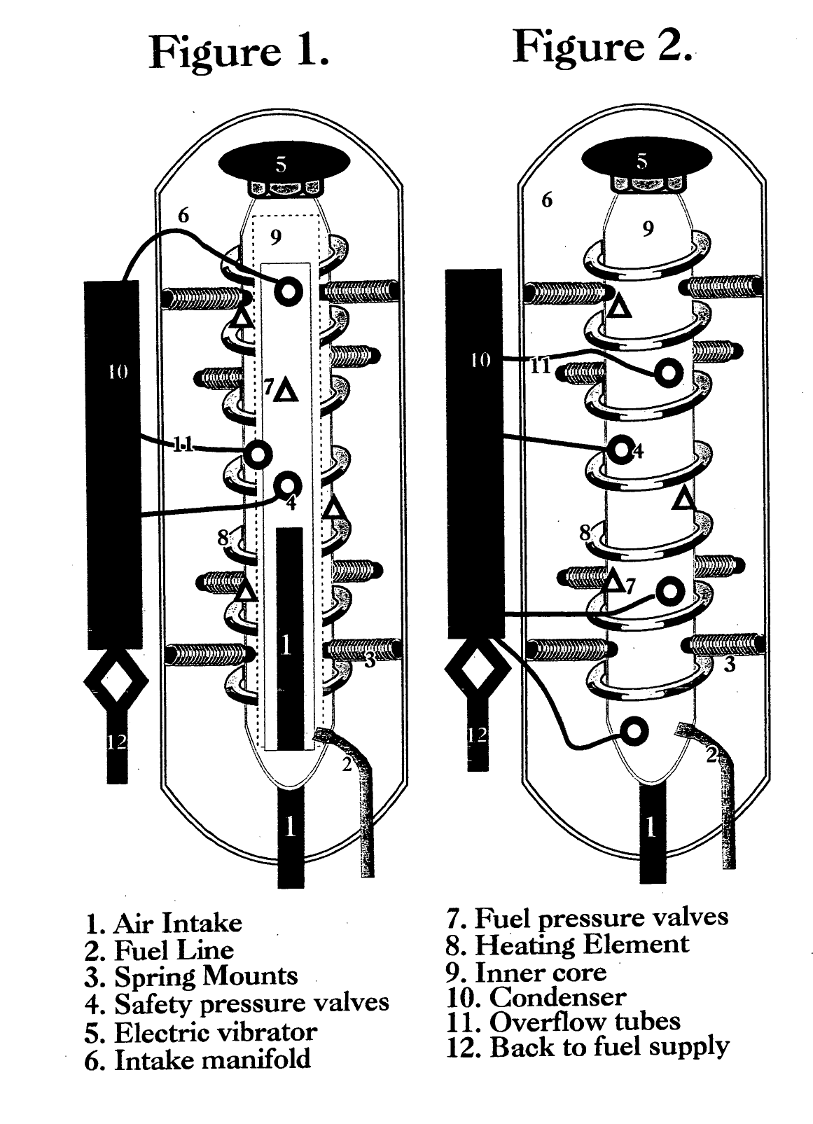

Referring now to FIG. 1, a fuel vaporizer 20 is shown with an inner core 9 that is supplied by an air intake 1. The inner core 9 has multiple off-set openings that are computerized to open only when submerged in fuel. This allows the system to work at any angle for example steep grades and angles dealt with by four wheel drive vehicles in mountainous regions or airplanes. A fuel line 2 feeds fuel to the inner core 9 to a particular fuel level. A computerized system maintains the inner core 9 to a fuel level of approximately half full leaving room for vaporization action to happen. The fuel is vibrated by an electric vibrator 5 with the inner core 9 being suspended on spring mounts 3. The electric vibrator 5 may be an electrical vibration motor.

In FIG. 1 the inner core 9 also has safety pressure valves 4 computerized so that excessive pressure is sent to a condenser 10 to turn excessive vapors back to liquid which is returned to fuel tank 12. An intake manifold 6 creates an outer chamber. The outer chamber is where the vapors collect immediately before being transferred into the cylinders of an internal combustion engine. The inner core 9 has multiple valves such as fuel pressure valve 7 that are computerized to release vapors when correct pressure is achieved. A heating element 8 further adds to the vaporizing of the fuel. The inner core 9 is the fuel chamber that contains the fuel vaporization processes. Overflow tubes 11 in conjunction with the safety pressure valves 4 carry excessive vapors to the condenser 10 to be re-liquefied and returned to the fuel tank 12. The shape of the invention is irrelevant and can be changed to suit any particular needs. In FIG. 2 the inner core 9 is not section to show the heating elements 8 winding around the inner core 9.

While the present invention has been related in terms of the foregoing embodiments, those skilled in the art will recognize that the invention is not limited to the embodiments depicted. The present invention can be practiced with modification and alteration within the spirit and scope of the appended claims. Thus, the description is to be regarded as illustrative instead of restrictive on the present invention.

1. (canceled)

2. A fuel vaporizer comprising:
an intake manifold
an inner core inside the intake manifold the inner core having a air intake and fuel line;
a heating element winding around the inner core;
a vibrator connected to the inner core;
at least one fuel pressure valve on the inner core to supply vaporized fuel to the intake manifold, the fuel pressure valve placed on the inner core in an offset pattern to allow the fuel vaporizer to function in and position;
at least one safety pressure valve on the inner core to release excess vapors; and
at least one overflow tube that connects the safety pressure valve to a condenser.

3. The device of claim 1 wherein the vibrator has an electrical motor.

4. A method comprising:
supplying a fuel to an inner core;
vaporizing the fuel inside the inner core by heating and shaking the fuel;
outleting the vaporized fuel to an intake manifold; and
condensing excess fuel vapor from the inner core.

5. A fuel vaporizer comprising:
an intake manifold
an inner core inside the intake manifold the inner core having a air intake and fuel line;
a heating element disposed around the inner core;
a vibrator connected to the inner core;
at least one fuel pressure valve on the inner core to supply vaporized fuel to the intake manifold;
at least one safety pressure valve on the inner core; and
at least one overflow tube that connects the safety pressure valve to a condenser.

6. The device of claim 5 wherein the heating element is wound around the inner core.

7. The device of claim 5 wherein the fuel pressure valve is placed on the inner core in an offset pattern to allow the fuel vaporizer to function in and position.

8. The device of claim 5 wherein the at least one safety pressure valve is to release excess vapors.

9. The device of claim 5 wherein the vibrator has an electrical motor.
